(19) United States
(12) Patent Application Publication
(10) Pub. No.: US 2023/0016151 A1
(43) Pub. Date: Jan. 19, 2023

(54) ELECTRONIC DEVICE AND METHOD OF OPERATING THE SAME

(71) Applicant: SAMSUNG ELECTRONICS CO., LTD., Suwon-si (KR)

(72) Inventors: Joohyoung KO, Suwon-si (KR); Byungki PARK, Suwon-si (KR); Kumjong SUN, Suwon-si (KR); Junseok LEE, Suwon-si (KR)

(21) Appl. No.: 17/880,304

(22) Filed: Aug. 3, 2022

Related U.S. Application Data
(63) Continuation of application No. PCT/KR2022/009845, filed on Jul. 7, 2022.

(30) Foreign Application Priority Data
Jul. 9, 2021 (KR) 10-2021-0090300

(51) Int. Cl. G06V 40/13; G09G 3/3225

(52) U.S. Cl. CPC G06V 40/1318; G09G 3/3225; G09G 2360/145; G09G 2330/021; G09G 2360/16

(57) ABSTRACT

An electronic device according to an example embodiment may include a fingerprint sensor configured to perform at least one of a fingerprint detection function of detecting a fingerprint and an illuminance measurement function of measuring an illuminance value in a light receiving area. The electronic device may include a display configured to display an image on a panel based on a changed luminance The electronic device may include a processor configured to: activate a light receiving area of at least a portion of the fingerprint sensor based on whether the display is activated, and change a luminance of the display based on an illuminance value measured from the light receiving area in an off state in which pixels arranged on a panel of the display do not display an image.

### CROSS-REFERENCE TO RELATED APPLICATIONS

This application is a continuation of International Application No. PCT/KR2022/009845 designating the United States, filed on Jul. 7, 2022, in the Korean Intellectual Property Receiving Office and claiming priority to Korean Patent Application No.

10-2021-0090300, filed on Jul. 9, 2021, in the Korean Intellectual Property Office, the disclosures of which are incorporated by reference herein in their entireties.

### BACKGROUND

### 1. Field

The disclosure relates to an electronic device and a method of operating the electronic device.

### 2. Description of Related Art

Mobile communication terminals, such as mobile phones and personal digital assistants, have evolved into multimedia combination devices. Accordingly, additional functions, such as digital cameras, MP3 players, or televisions (TVs), have been grafted onto mobile communication terminals. In addition, various sensors, such as a gyro sensor, an image sensor, or an illuminance sensor, may be included in a mobile communication terminal to provide various additional functions. For example, if an illuminance sensor is used, a luminance of a display of the mobile communication terminal may be changed. If the illuminance sensor is used, an image with a brightness suitable for user's eyes may be provided, and current consumption may also be reduced.

### SUMMARY

According to an example embodiment, a method of operating an electronic device including a display and a fingerprint sensor may include: activating a light receiving area of at least a portion of the fingerprint sensor based on whether the display is activated; measuring an illuminance value from the light receiving area in an off state in which pixels arranged on a panel of the display do not display an image; and changing a luminance of the display based on the illuminance value.

According to an example embodiment, an electronic device may include: a fingerprint sensor configured to perform at least one of a fingerprint detection function of detecting a fingerprint and an illuminance measurement function of measuring an illuminance value in a light receiving area; a display configured to display an image on a panel based on a changed luminance; and a processor configured to: activate a light receiving area of at least a portion of the fingerprint sensor based on whether the display is activated, measure an illuminance value from the light receiving area in an off state in which pixels arranged on the panel of the display do not display an image, and change a luminance of the display based on the illuminance value.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of an electronic device according to various embodiments;

FIG. 3 is a flowchart illustrating an example method of operating an electronic device according to various embodiments;

FIG. 4 is a flowchart illustrating an example method of determining an illuminance measurement mode according to various embodiments;

FIG. 5 is a flowchart illustrating an example method of measuring a second illuminance value based on whether an illuminance measurement mode is switched, according to various embodiments;

FIGS. 6A and 6B are diagrams illustrating a first light receiving area and a second light receiving area of a fingerprint sensor according to various embodiments;

FIG. 7 is a flowchart illustrating an example method of changing a luminance of a display according to various embodiments;

FIG. 8 is a flowchart illustrating an example method of operating an electronic device to change a luminance of a display based on a remaining capacity of a battery according to various embodiments;

FIG. 9 is a flowchart illustrating an example method of operating an electronic device to change an illuminance measurement interval based on a remaining capacity of a battery according to various embodiments;

FIG. 10 is a flowchart illustrating an example method of operating an electronic device when a display is in an active state according to various embodiments;

FIG. 11 is a flowchart illustrating an example method of operating an electronic device to change a luminance of a display by measuring an illuminance value according to various embodiments;

FIG. 12 is a flowchart illustrating an example method of operating the electronic device to perform a fingerprint detection function and an illuminance measurement function when a display is deactivated according to various embodiments; and

FIG. 13 is a flowchart illustrating an example method of operating the electronic device to perform a fingerprint detection function and an illuminance measurement function when a display is activated according to various embodiments.

### DETAILED DESCRIPTION

Hereinafter, various example embodiments will be described in greater detail with reference to the accompanying drawings. When describing the various example embodiments with reference to the accompanying drawings, like reference numerals refer to like elements and a description related thereto may not be repeated.

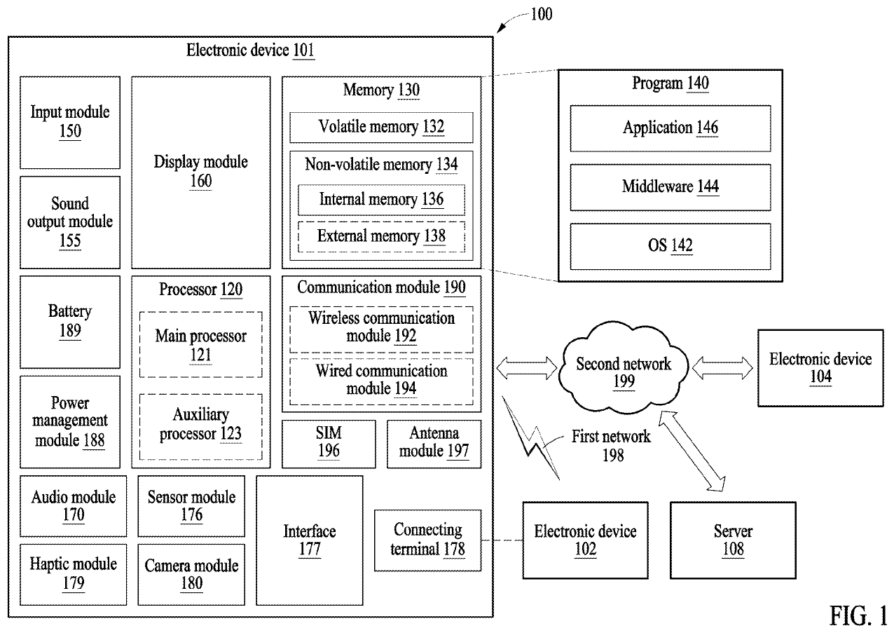

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an example embodiment, the electronic device 101 may communicate with the electronic device 104 via the server 108. According to an example embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In various example embodiments, at least one of the components (e.g., the connecting terminal 178) may be omitted from the electronic device 101, or one or more other components may be added in the electronic device 101. In various example embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an example embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an example embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an example embodiment, the auxiliary processor 123 (e.g., an ISP or a CP) may be implemented as a portion of another component (e.g., the camera module 180 or the communication module 190) that is functionally related to the auxiliary processor 123. According to an example embodiment, the auxiliary processor 123 (e.g., an NPU) may include a hardware structure specified for artificial intelligence model processing. An artificial intelligence model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an example embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to an example embodiment, the display module 160 may include a touch sensor adapted to detect a touch, or a pressure sensor adapted to measure the intensity of force incurred by the touch.

The audio module 170 may convert a sound into an electric signal or vice versa. According to an example embodiment, the audio module 170 may obtain the sound via the input module 150 or output the sound via the sound output module 155 or an external electronic device (e.g., the electronic device 102 such as a speaker or a headphone) directly or wirelessly connected to the electronic device 101.

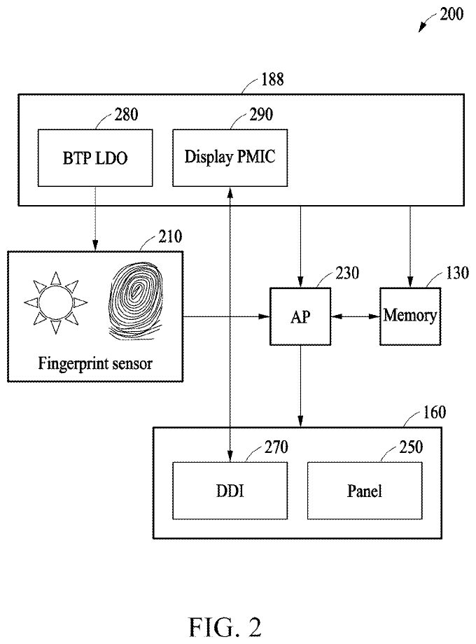

The sensor module 176 may detect an operational state (e.g., power or temperature) of the electronic device 101 or an environmental state (e.g., a state of a user) external to the electronic device 101, and generate an electrical signal or data value corresponding to the detected state. According to an example embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or a fingerprint sensor (e.g., a fingerprint sensor 210 of FIG. 2). The fingerprint sensor 210 may be, for example, an optical fingerprint sensor.

The interface 177 may support one or more specified protocols to be used for the electronic device 101 to be coupled with the external electronic device (e.g., the electronic device 102) directly (e.g., wiredly) or wirelessly. According to an example embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an example embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an example embodiment, the haptic module 179 may include, for example, a motor, a piezoelectric element, or an electric stimulator.

The camera module 180 may capture a still image and moving images. According to an example embodiment, the camera module 180 may include one or more lenses, image sensors, image signal processors, or flashes.

The power management module 188 may manage power supplied to the electronic device 101. According to an example embodiment, the power management module 188 may be implemented as, for example, at least a part of a power management integrated circuit (PMIC).

The battery 189 may supply power to at least one component of the electronic device 101. According to an example embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an example embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an example embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an example embodiment, the antenna module 197 may include an antenna including a radiating element including a conductive material or a conductive pattern formed in or on a substrate (e.g., a printed circuit board (PCB)). According to an example embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an example embodiment, another component (e.g., a radio frequency integrated circuit (RFIC)) other than the radiating element may be additionally formed as a part of the antenna module 197.

According to various example embodiments, the antenna module 197 may form a mmWave antenna module. According to an example embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an example embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an example embodiment, the external electronic device 104 may include an Internet-of-things (IoT) device. The server 108 may be an intelligent server using machine learning and/or a neural network. According to an example embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

FIG. 2 is a block diagram illustrating an example configuration of an electronic device according to various embodiments. Referring to FIG. 2, an electronic device 200 (e.g., the electronic device 101 of FIG. 1) according to an example embodiment may correspond to an electronic device configured to perform fingerprint recognition and/or fingerprint authentication by a fingerprint of a user sensed by the fingerprint sensor 210 and simultaneously measure an illuminance value by the fingerprint sensor 210.

Hereinafter, for convenience of description, an example of the electronic device 200 will be mainly described based on an operation of a user terminal, however, this is merely an example. For example, electronic devices other than the user terminal may also be used as the electronic device 200. The electronic device 200 may include, for example, a portable communication device (e.g., a smartphone), a computer device, a portable multimedia device, a portable medical device, a camera, a wearable device, or a home appliance device. According to an example embodiment of the disclosure, the electronic device 200 is not limited to those described above.

The electronic device 200 may include, for example, the fingerprint sensor 210, an AP 230 (e.g., the processor 120 of FIG. 1), a display 160, a power management module (e.g., including power management circuitry) 188, and a memory 130. The power management module 188 may include the battery 189, or may be provided separately from the battery 189.

The fingerprint sensor 210 may perform a fingerprint detection function of detecting a fingerprint of a user, and an illuminance measurement function of measuring an illuminance value in a light receiving area of the fingerprint sensor 210. The fingerprint detection function, which may refer, for example, to a basic function of the fingerprint sensor 210, may be performed as a security function for authentication of a user whose fingerprint is enrolled and input. The illuminance measurement function may correspond to an additional function of the fingerprint sensor 210. The illuminance measurement function may be performed after the electronic device 200 is booted.

The illuminance measurement function of the fingerprint sensor 210 may be automatically performed, or may be stopped according to settings of a user. In an example, when the user sets a “brightness optimization” item among setting items included in a function menu of the electronic device 200 to “on”, the illuminance measurement function of the fingerprint sensor 210 may be automatically performed. In another example, when the user sets the “brightness optimization” item among the setting items of the electronic device 200 to “off”, the illuminance measurement function of the fingerprint sensor 210 may be stopped. When the “brightness optimization” item is set to “off”, the electronic device 200 may maintain a luminance (value) of the display 160 set by the user, instead of performing an operation of optimizing a brightness by changing the luminance of the display 160 based on an illuminance value.

The fingerprint sensor 210 may be, for example, an optical fingerprint sensor including a photodiode. The photodiode may be a device that generates photocharges by absorbing external light. A photodiode of a pixel selected as the fingerprint sensor 210 may supply an electrical analog signal of current or voltage according to external light (brightness). The photodiode may include, for example, a PN photodiode, a PIN photodiode, an avalanche photodiode, and the like, but is not necessarily limited thereto.

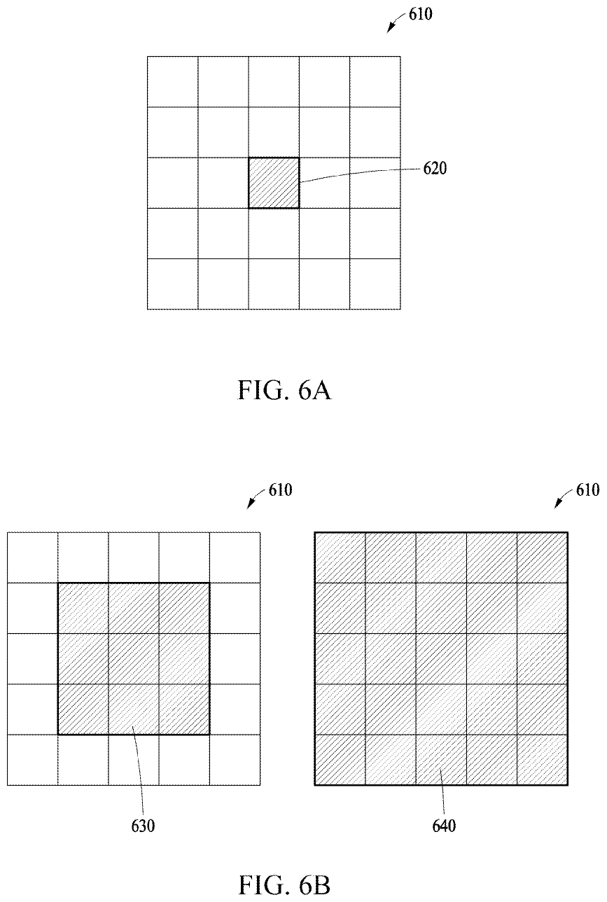

The fingerprint sensor 210 according to an example embodiment may support two illuminance measurement modes, e.g., a first mode and a second mode, in measuring an illuminance value. The “first mode” may correspond to a mode of measuring an illuminance value by activating a first light receiving area (e.g., a first light receiving area 620 of FIG. 6A) of a photodiode included in the fingerprint sensor 210. An illuminance value measured from the first light receiving area 620 of the photodiode according to the first mode may be referred to as a “first illuminance value”. The “second mode” may correspond to a mode of measuring an illuminance value by activating a second light receiving area (e.g., a second light receiving area 630 or 640 of FIG. 6B) of the photodiode included in the fingerprint sensor 210. An illuminance value measured from the second light receiving area 630 or 640 of the photodiode according to the second mode may be referred to as a “second illuminance value”.

The second light receiving area 630 or 640 may be greater than the first light receiving area 620, which will be described in greater detail below with reference to FIGS. 6A and 6B. For example, if the first light receiving area 620 is a partial area of the photodiode, the second light receiving area 630 or 640 may be a plurality of areas of the photodiode or substantially the entire area of the photodiode. Since the first light receiving area 620 according to the first mode corresponds to a partial area of the photodiode, the first mode may also be referred to as a “partial mode”. In addition, since the second light receiving area 630 or 640 according to the second mode corresponds to the plurality of areas or substantially the entire area of the photodiode, the second mode may also be referred to as a “full mode”. The illuminance measurement mode of the fingerprint sensor 210 may be changed according to a control signal of the AP 230.

The fingerprint sensor 210 may operate in the first mode or the second mode under a control of the AP 230 to perform the illuminance measurement function. For example, when the illuminance measurement mode is the first mode, the first light receiving area 620 of the photodiode in the fingerprint sensor 210 may be activated based on the control of the AP 230 so that the first illuminance value may be measured from the first light receiving area 620. When the illuminance measurement mode is the second mode, the second light receiving area 630 or 640 of the photodiode in the fingerprint sensor 210 may be activated based on the control of the AP 230 so that the second illuminance value may be measured from the second light receiving area 630 or 640.

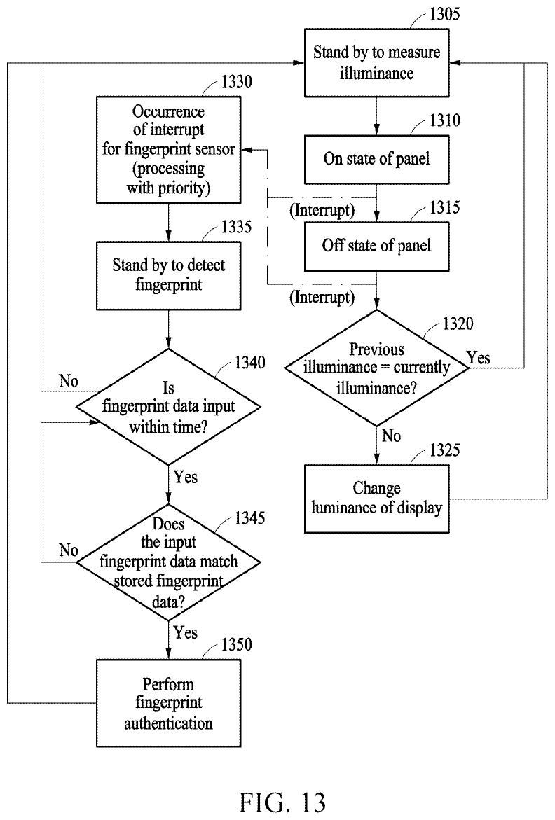

For example, when the display 160 includes an active-matrix organic light-emitting diode (AMOLED), the fingerprint sensor 210 may receive light based on an AMOLED off ratio (AOR) of the AMOLED of the display 160 in response to activation of the display 160. The AOR will be described in greater detail below with reference to FIG. 13.

The AP 230 may include various processing circuitry and process sensor information detected or measured by the fingerprint sensor 210. The AP 230 may obtain an illuminance value or illuminance data from the fingerprint sensor 210 and use the illuminance value or illuminance data to adjust the luminance of the display 160. A “luminance” may refer, for example, to a degree of glare and an amount of light reflected from a target surface, and may correspond to an intensity of light indicating a degree of brightness. The luminance may correspond to the overall impression of a space and may be used to evaluate lightness and darkness. An “illuminance” may refer, for example, to a degree of brightness and an amount of light incident on a point on a target surface. The Illuminance may be an absolute value that is physically calculated, and the unit of illuminance is lux and abbreviated as lx. In other words, the illuminance may be, strictly speaking, a brightness of light that is less likely to be recognized by people. In most situations where a person feels “bright”, an illuminance and a sense of brightness experienced by the person may be different, because light from a light source is reflected from a target surface and enters an eye and converted into an electronic signal to be perceived in a brain. In other words, this is because human eyes are designed to perceive lightness and darkness of a space by a relative brightness, even though the illuminance is accurate because the illuminance is an absolute value that is physically calculated. The AP 230 may optimize a level of brightness perceived by a user by adjusting the luminance of the display 160 according to the illuminance

The AP 230 may match the illuminance value or illuminance data received from the fingerprint sensor 210 to an illuminance table that is provided in advance. The “illuminance table” may refer, for example, to a table in which an illuminance value corresponding to a signal generated in the fingerprint sensor 210 is matched to a level of illuminance (Lux). The illuminance table may be provided for each mode (e.g., the first mode and the second mode). For example, in the illuminance table, signals generated by exposing each illuminance in a first mode or a second mode may be matched and stored in the fingerprint sensor 210 of the electronic device 200 assembled with a window transmittance sample (e.g., a Typ/Min/Max sample). Since light receiving areas activated in the fingerprint sensor are different for each of the first mode and the second mode, signals generated according to the illuminance may also be different for each mode. Accordingly, illuminance tables for each mode may also be different.

The AP 230 may determine one of a first mode of activating the first light receiving area 620 of the fingerprint sensor 210 and a second mode of activating the second light receiving area 630 or 640 of the fingerprint sensor 210 as an illuminance measurement mode, based on whether the display 160 is activated. In an example, when the display 160 is deactivated to be in an off state, the AP 230 may determine the first mode as the illuminance measurement mode. In another example, when the display 160 is activated to be in an on state, the AP 230 may determine the second mode as the illuminance measurement mode. The “display 160 being deactivated” may be understood as a state in which power is not applied to the display 160 such that the display 160 is turned off, that is, the off state of the display 160. In addition, the “display 160 being activated” may be understood as a state in which power is applied to the display 160 such that the display 160 is turned on, that is, the on state of the display 160.

When the first mode is determined as the illuminance measurement mode, the AP 230 may determine whether to switch the illuminance measurement mode to the second mode based on a variation in the first illuminance value measured in the first light receiving area 620, and may measure the second illuminance value from the second light receiving area 630 or 640. When the second mode is determined as the illuminance measurement mode, the AP 230 may measure the second illuminance value from the second light receiving area 630 or 640 in an off state in which pixels arranged on a panel 250 of the display 160 do not display an image.

The AP 230 may change the luminance of the display 160 based on a comparison result of a current second illuminance value currently measured in the second light receiving area 630 or 640 and a previous second illuminance value measured in the second mode at a previous point in time according to an illuminance measurement interval of the fingerprint sensor 210. For example, when the previous second illuminance value and the current second illuminance value are different, the AP 230 may change the luminance of the display 160 based on the current second illuminance value. The AP 230 may transmit data associated with the changed luminance and/or mobile industry processor interface (MIPI) data to a display driver integrated circuit (DDI) 270 of the display 160. An operation of the AP 230 will be described in more detail through the following example embodiments.

The memory 130 may store a program to allow the electronic device 200 to recognize a fingerprint and/or measure an illuminance value. For example, the program may include a module configured to perform an operation related to setting of the fingerprint sensor 210 to activate an illuminance sensing function of the fingerprint sensor 210 for each illuminance measurement mode, and a module configured to determine or adjust the luminance of the display 160 based on data received from the fingerprint sensor 210, but is not limited thereto.

The display 160 may output a screen through the panel 250 in which pixels displaying an image are arranged. The display 160 may include the panel 250 and the DDI 270. The DDI 270 may receive an image and luminance (luminance data) from the AP 230. The image and luminance transmitted to the DDI 270 may be shared with the panel 250 and may be output. Power for outputting an image (including luminance data) to the panel 250 of the display 160 may be supplied through a display power management integrated circuit (PMIC) 290 included in the power management module 188. The display PMIC 290 may perform power management of a display, for example, an output voltage, sequencing, and a voltage monitoring threshold for the display. The display 160 may include, for example, an AMOLED, but is not limited thereto.

The power management module 188 may supply power to the electronic device 200. For example, the power management module 188 may supply power required to operate the fingerprint sensor 210, the AP 230, the memory 130, and the display 160.

The power management module 188 may supply power to the display 160 through, for example, the display PMIC 290, and may supply power to the fingerprint sensor 210 through a BTP LDO 280. The BTP LDO 280 may supply analog power and input/output (I/O) power required when the fingerprint sensor 210 operates.

The power management module 188 may include a battery (not shown) (e.g., the battery 189 of FIG. 1), or the battery may be provided separately.

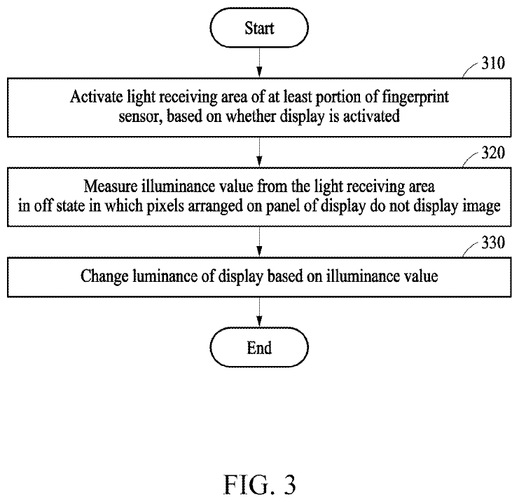

FIG. 3 is a flowchart illustrating an example method of operating an electronic device 200 according to various embodiments. In the following examples, operations may be performed sequentially, but not necessarily performed sequentially. For example, the order of the operations may be changed and at least two of the operations may be performed in parallel.

The electronic device 200 (e.g., the electronic device 101 of FIG. 1) including a display 160 and a fingerprint sensor 210 according to an example embodiment may measure an illuminance value and change a luminance of the display 160 based on the illuminance value, through operations 310 to 330.

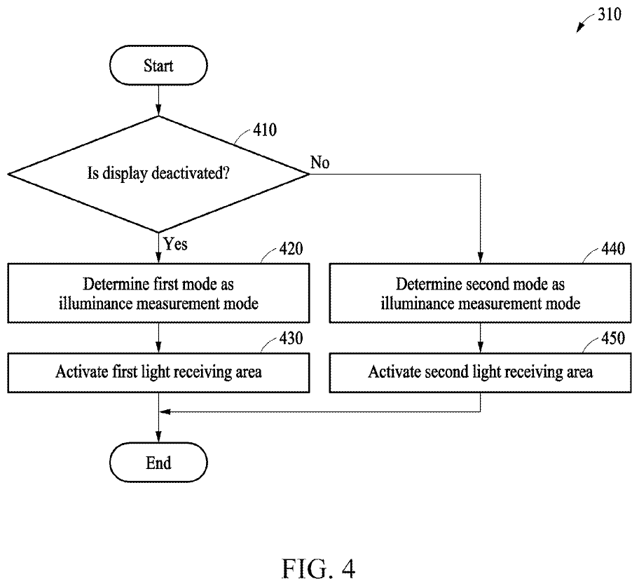

In operation 310, the electronic device 200 may activate a light receiving area (e.g., the first and second light receiving areas 620, 630, and 640) of at least a portion of the fingerprint sensor 210, based on whether the display 160 is activated. The light receiving area may be, for example, a first light receiving area 620 or a second light receiving area 630 or 640, which will be described below. The electronic device 200 may determine an illuminance measurement mode of the fingerprint sensor 210 based on whether the display 160 is activated, and may activate a corresponding light receiving area (e.g., the first and second light receiving areas 620, 630, and 640) for each illuminance measurement mode. A method by which the electronic device 200 activates the light receiving area will be described in more detail with reference to FIG. 4 below.

In operation 320, the electronic device 200 may measure an illuminance value (e.g., a second illuminance value) from the second light receiving area 630 or 640 in an off state in which pixels arranged on a panel 250 of the display 160 do not display an image.

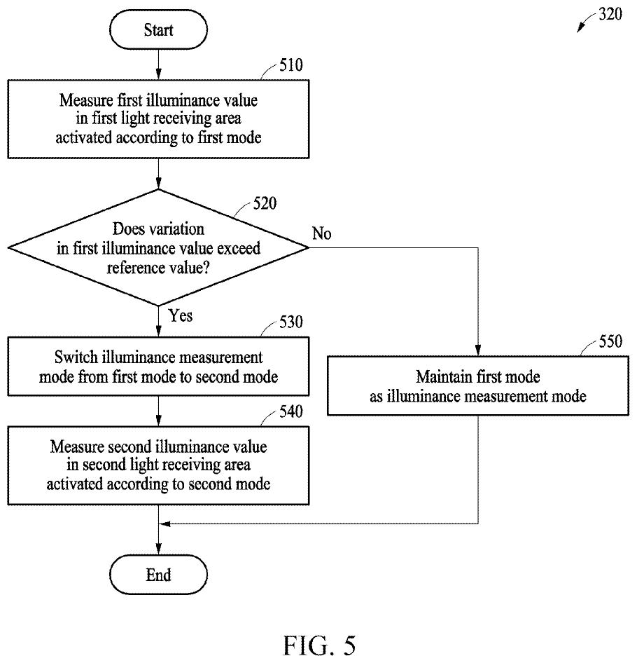

Operation 320 may correspond to an operation performed when the display 160 of the electronic device 200 is activated, for example, when the display 160 is turned on. For example, in a state in which the display 160 is activated, that is, in a state in which the display 160 emits light, it may be difficult to accurately measure external light due to the emitted light, which will be described in more detail below. Accordingly, when the display 160 is activated, the electronic device 200 may measure the illuminance value in the off state in which the pixels arranged on the panel 250 of the display 160 do not display an image. In addition, when the display 160 is activated, the second mode may be determined as the illuminance measurement mode, and the electronic device 200 may measure the second illuminance value from the second light receiving area 630 or 640 according to the second mode. A method by which the electronic device 200 measures an illuminance value will be described in greater detail below with reference to FIG. 5.

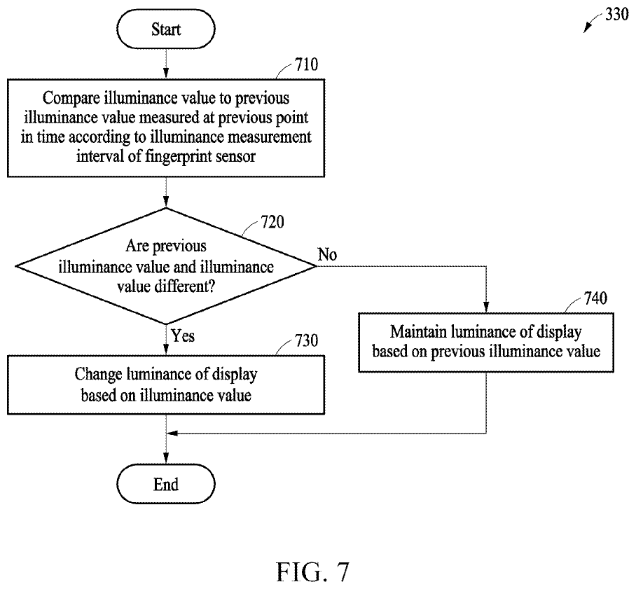

In operation 330, the electronic device 200 may change the luminance of the display 160 based on the illuminance value measured in operation 320. A method by which the electronic device 200 changes the luminance of the display 160 will be described in greater detail below with reference to FIG. 7.

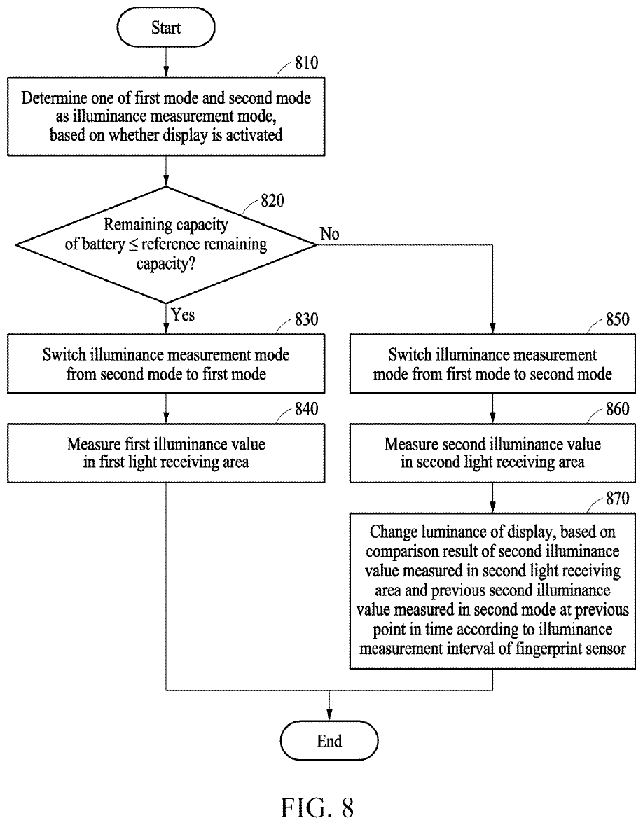

According to an example embodiment, the electronic device 200 may also switch the illuminance measurement mode of the fingerprint sensor 210 based on a remaining capacity of the battery 189. An example embodiment in which the electronic device 200 switches the illuminance measurement mode based on the remaining capacity of the battery 189 will be described in more detail with reference to FIG. 8 below.

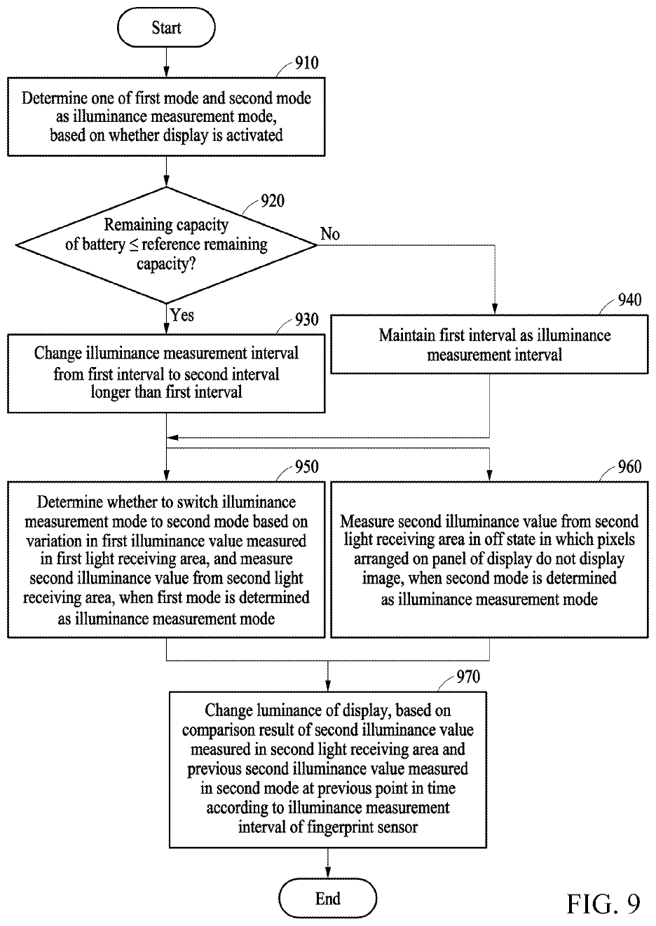

Also, the electronic device 200 may change an illuminance measurement interval of the fingerprint sensor 210 based on the remaining capacity of the battery 189. An example embodiment in which the electronic device 200 changes the illuminance measurement interval based on the remaining capacity of the battery 189 will be described in greater detail below with reference to FIG. 9.

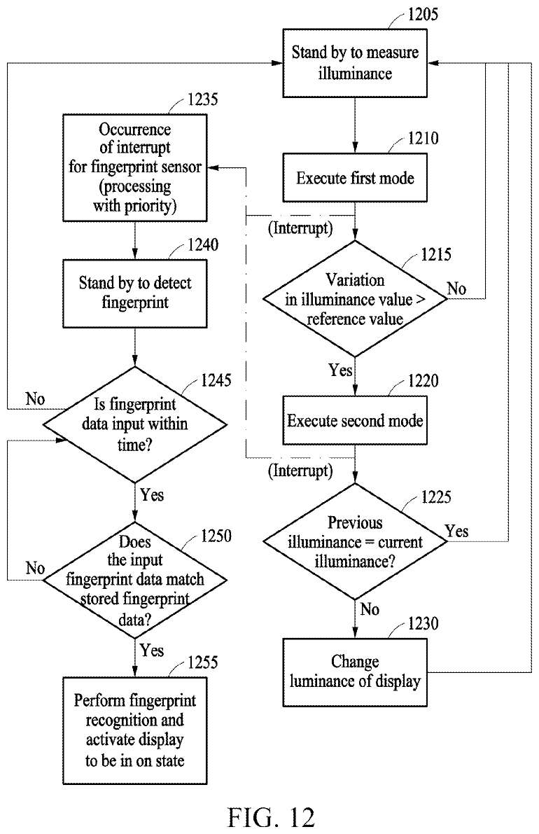

In addition, an example embodiment in which the fingerprint sensor 210 performs a fingerprint detection function and an illuminance measurement function together will be described in greater detail below with reference to FIGS. 12 and 13.

FIG. 4 is a flowchart illustrating an example method of determining an illuminance measurement mode according to various embodiments. In the following examples, operations may be performed sequentially, but not necessarily performed sequentially. For example, the order of the operations may be changed and at least two of the operations may be performed in parallel.

The electronic device 200 (e.g., the electronic device 101 of FIG. 1) according to an example embodiment may determine an illuminance measurement mode through operations 410 to 440.

In operation 410, the electronic device 200 may determine whether the display 160 is activated (or deactivated). The electronic device 200 may determine whether the display 160 is activated based on a control signal of the display 160, however, the example embodiments are not necessarily limited thereto. When a control signal to supply power to the display 160 or to transmit data to the display 160 exists, the electronic device 200 may determine that the display 160 is activated. When a screen output is required by a power key and a wake-up function of a sensor, the electronic device 200 may also determine that the display 160 is activated.

In operation 410, the electronic device 200 may determine one of a first mode of activating the first light receiving area 620 among the light receiving areas 620, 630, and 640 and a second mode of activating the second light receiving area 630 or 640 among the light receiving areas 620, 630 and 640 as an illuminance measurement mode, based on whether the display 160 is activated.

When the display 160 is determined to be deactivated in operation 410, the electronic device 200 may determine the first mode as the illuminance measurement mode in operation 420. When the first mode is determined as the illuminance measurement mode, the electronic device 200 may activate the first light receiving area 620 of the photodiode of the fingerprint sensor 210 in operation 430.

When the display 160 is determined to be activated in operation 410, the electronic device 200 may determine the second mode as the illuminance measurement mode in operation 440. When the second mode is determined as the illuminance measurement mode, the electronic device 200 may activate the second light receiving area 630 or 640 of the photodiode of the fingerprint sensor 210 in operation 450.

FIG. 5 is a flowchart illustrating an example method of measuring a second illuminance value based on whether an illuminance measurement mode is switched, according to various embodiments. In the following examples, operations may be performed sequentially, but not necessarily performed sequentially. For example, the order of the operations may be changed and at least two of the operations may be performed in parallel.

The electronic device 200 (e.g., the electronic device 101 of FIG. 1) according to an example embodiment may measure an illuminance value through operations 510 to 550.

In operation 510, the electronic device 200 may measure a first illuminance value in the first light receiving area 620 activated according to the first mode. The electronic device 200 may measure the first illuminance value in the first light receiving area 620 at a preset illuminance measurement interval (e.g., 1 second (s)).

In operation 520, the electronic device 200 may determine whether to switch the illuminance measurement mode to the second mode, based on a variation in the first illuminance value. The electronic device 200 may determine whether the variation in the first illuminance value exceeds a preset reference value. The electronic device 200 may use, for example, an illuminance table of the first mode in which an illuminance value is mapped to an amount of light sensed by the fingerprint sensor 210 in the first mode, to determine whether the variation in the first illuminance value exceeds the preset reference value. For example, the electronic device 200 may calculate the variation in the first illuminance value with respect to illuminance values described in the illuminance table of the first mode by matching the first illuminance value with the illuminance table of the first mode. The electronic device 200 may determine whether the calculated variation exceeds the reference value. The reference value may be, for example, ±5%, but is not necessarily limited thereto.

In operation 520, the electronic device 200 may determine whether the variation in the first illuminance value exceeds the reference value. The electronic device 200 may determine whether to switch the illuminance measurement mode to the second mode based on the variation in the first illuminance value measured in the first light receiving area 620. The “variation in the first illuminance value” may refer, for example, to a difference between a first illuminance value measured at a previous time step (e.g., “t−1” seconds) and a first illuminance value measured at a current time step (e.g., “t” seconds).

In an example, when the variation does not exceed the reference value in operation 520, the electronic device 200 may maintain the first mode as the illuminance measurement mode in operation 550. In this example, the electronic device 200 may newly measure a first illuminance value in the first light receiving area 620 according to a preset illuminance measurement interval, or may store the first illuminance value measured in operation 510, instead of switching the illuminance measurement mode.

When the variation exceeds the reference value in operation 520, the electronic device 200 may switch the illuminance measurement mode from the first mode to the second mode in operation 530.

In operation 540, the electronic device 200 may measure a second illuminance value in the second light receiving area 630 or 640 activated according to the second mode switched in operation 530 among light receiving areas.

FIGS. 6A and 6B are diagrams illustrating the first light receiving area 620 and the second light receiving area 630 or 640 of the fingerprint sensor 210 according to various embodiments. FIG. 6A illustrates the first light receiving area 620 of an entire light receiving area 610 of the photodiode of the fingerprint sensor 210.

If the entire light receiving area 610 is assumed to occupy the entire area ( 25/25) of the photodiode, the first light receiving area 620 may correspond to 1/25 of the entire area of the photodiode. When only the first light receiving area 620 is activated according to the first mode, current consumption may be significantly reduced in comparison to when the entire light receiving area 610 is activated. For example, when only the first light receiving area 620 is activated, the fingerprint sensor 210 may operate at a current of about 1 milliampere (mA).

FIG. 6B illustrates the second light receiving area 630 or 640 of the entire light receiving area 610 of the photodiode of the fingerprint sensor 210 according to various embodiments. The second light receiving area 630 or 640 may be greater area than the first light receiving area 620.

For example, when the entire light receiving area 610 occupies the entire area ( 25/25) of the photodiode, the second light receiving area 630 may correspond to 9/25 of the entire area of the photodiode, and the second light receiving area 640 may correspond to 25/25 that is the same as the entire light receiving area 610.

Since the area of the second light receiving area 630 or 640 is greater than that of the first light receiving area 620, an illuminance measurement accuracy may be enhanced even though current consumption is increased in comparison to that of the first light receiving area 620.

FIG. 7 is a flowchart illustrating an example method of changing the luminance of the display 160 according to various embodiments. In the following examples, operations may be performed sequentially, but not necessarily performed sequentially. For example, the order of the operations may be changed and at least two of the operations may be performed in parallel.

The electronic device 200 (e.g., the electronic device 101 of FIG. 1) according to an example embodiment may change the luminance of the display 160 through operations 710 to 740.

In operation 710, the electronic device 200 may compare a current illuminance value (e.g., a second illuminance value) measured in operation 320 to a previous illuminance value (e.g., a previous second illuminance value) measured at a previous point in time according to the illuminance measurement interval of the fingerprint sensor 210. For example, if the illuminance measurement interval is “3” seconds, the previous illuminance value may be an illuminance value measured 3 seconds before based on the current time. For example, the electronic device 200 may compare a previous second illuminance value measured in the second mode at a previous point in time to a current second illuminance value currently measured in the second light receiving area 630 or 640.

In operation 720, the electronic device 200 may determine whether the previous illuminance value and the current illuminance value are different.

In an example, when it is determined in operation 720 that the previous illuminance value and the current illuminance value are not different, that is, the same, based on a result of the comparing, the electronic device 200 may maintain the luminance of the display 160 based on the previous illuminance value in operation 740.

In an example, when it is determined in operation 720 that the previous illuminance value and the current illuminance value are different, based on the result of the comparing, the electronic device 200 may change the luminance of the display 160 based on the current illuminance value in operation 730. For example, if the display 160 that is deactivated is activated, the electronic device 200 may wake up the display 160 by applying the changed luminance.

FIG. 8 is a flowchart illustrating an example method of operating the electronic device 200 to change a luminance of a display based on a remaining capacity of a battery according to various embodiments. In the following examples, operations may be performed sequentially, but not necessarily performed sequentially. For example, the order of the operations may be changed and at least two of the operations may be performed in parallel.

The electronic device 200 (e.g., the electronic device 101 of FIG. 1) according to an example embodiment may change the luminance of the display 160 by switching the illuminance measurement mode based on the remaining capacity of the battery 189 through operations 810 to 870.

In operation 810, the electronic device 200 may determine one of the first mode and the second mode as the illuminance measurement mode, based on whether the display 160 is activated. For example, the electronic device 200 may determine the first mode as the illuminance measurement mode when the display is deactivated, and may determine the second mode as the illuminance measurement mode when the display is activated.

In operation 820, the electronic device 200 may determine whether the remaining capacity of the battery 189 is less than or equal to a preset reference remaining capacity (e.g., 15% of the remaining capacity of the battery 189).

In an example, it may be assumed that the remaining capacity of the battery 189 is determined to be less than or equal to the preset reference remaining capacity in operation 820. In this example, in operation 830, the electronic device 200 may switch the illuminance measurement mode from the second mode to the first mode. If the first mode is determined as the illuminance measurement mode in operation 810, the electronic device 200 may maintain the first mode without a change. If the second mode is determined as the illuminance measurement mode in operation 810, the electronic device 200 may switch the illuminance measurement mode from the second mode back to the first mode in operation 830.

When the illuminance measurement mode is switched to the first mode in operation 830, the electronic device 200 may measure a first illuminance value in the first light receiving area 620 according to the first mode in operation 840. Subsequently, after measuring the first illuminance value in the first light receiving area 620 according to a preset illuminance measurement interval, the electronic device 200 may terminate the operation or perform operation 810.

In another example, it may be assumed that the remaining capacity of the battery 189 is determined to be greater than the preset reference remaining capacity in operation 820. In this example, in operation 850, the electronic device 200 may switch the illuminance measurement mode from the first mode to the second mode. If the first mode is determined as the illuminance measurement mode in operation 810, the electronic device 200 may switch the illuminance measurement mode from the first mode to the second mode. If the second mode is determined as the illuminance measurement mode in operation 810, the electronic device 200 may maintain the second mode as the illuminance measurement mode without a change. In operation 860, the electronic device 200 may measure a second illuminance value from the second light receiving area 630 or 640 according to the second mode. In operation 870, the electronic device 200 may change the luminance of the display 160, based on a comparison result of the second illuminance value measured in the second light receiving area 630 or 640 in operation 860 and a previous second illuminance value measured in the second mode at a previous point in time according to an illuminance measurement interval of the fingerprint sensor 210.

FIG. 9 is a flowchart illustrating an example method of operating an electronic device to change an illuminance measurement interval based on a remaining capacity of a battery according to various embodiments. In the following examples, operations may be performed sequentially, but not necessarily performed sequentially. For example, the order of the operations may be changed and at least two of the operations may be performed in parallel.

An electronic device 200 (e.g., the electronic device 101 of FIG. 1) according to an example embodiment may measure an illuminance value according to an illuminance measurement interval changed based on the remaining capacity of a battery 189 and change the luminance of the display 160 through operations 910 to 970.

In operation 910, the electronic device 200 may determine one of the first mode and the second mode as the illuminance measurement mode, based on whether the display 160 is activated.

In operation 920, the electronic device 200 may determine whether the remaining capacity of the battery 189 of the electronic device 200 is less than or equal to a preset reference remaining capacity.

In an example, it may be assumed that the remaining capacity of the battery 189 is determined to be less than or equal to the preset reference remaining capacity in operation 920. In operation 930, the electronic device 200 may change the illuminance measurement interval from a first interval (e.g., 1 second) to a second interval (e.g., 3 seconds) longer than the first interval.

In another example, if it is determined in operation 920 that the remaining capacity of the battery 189 is greater than the preset reference remaining capacity, the electronic device 200 may maintain the first interval as the illuminance measurement interval in operation 940 without change.

If the first mode is determined as the illuminance measurement mode, the electronic device 200 may determine whether to switch the illuminance measurement mode to the second mode based on a variation in a first illuminance value measured in the first light receiving area 620, and may measure a second illuminance value from the second light receiving area 630 or 640 in operation 950.

If the second mode is determined as the illuminance measurement mode, the electronic device 200 may measure an illuminance value (e.g., a second illuminance value) from the second light receiving area 630 or 640 in an off state in which pixels arranged on a panel 250 of the display 160 do not display an image in operation 960.

In operation 970, the electronic device 200 may change the luminance of the display 160 based on a comparison result of the second illuminance value measured in the second light receiving area 630 or 640 and a previous second illuminance value measured in the second mode at a previous point in time according to an illuminance measurement interval of the fingerprint sensor 210.

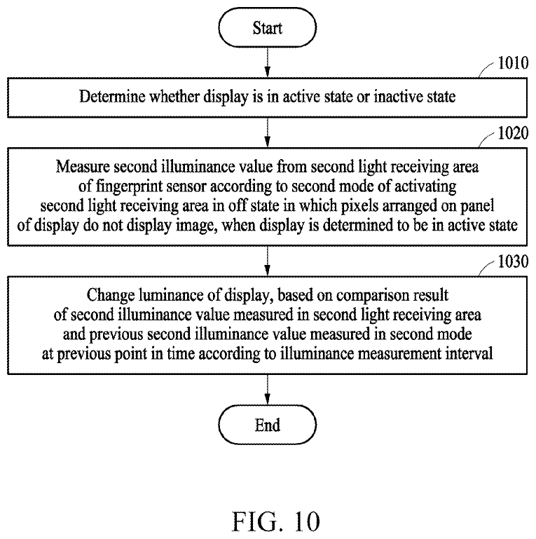

FIG. 10 is a flowchart illustrating an example method of operating the electronic device 200 when a display is in an active state according to various embodiments. In the following examples, operations may be performed sequentially, but not necessarily performed sequentially. For example, the order of the operations may be changed and at least two of the operations may be performed in parallel.

The electronic device 200 (e.g., the electronic device 101 of FIG. 1) including the display 160 and the fingerprint sensor 210 according to an example embodiment may change the luminance of the display 160 by measuring an illuminance value when the display 160 is in the active state, through operations 1010 to 1030.

In operation 1010, the electronic device 200 may determine whether the display 160 is in the active state or inactive state. The electronic device 200 may determine whether the display 160 is activated, for example, based on at least one of a sensing signal of the fingerprint sensor 210 and a control signal of the electronic device 200, however, the example embodiments are not necessarily limited thereto.

For example, it may be assumed that the display 160 is determined to be in the active state in operation 1010. In this example, in operation 1020, the electronic device 200 may measure a second illuminance value from the second light receiving area 630 or 640 of the fingerprint sensor 210 according to a second mode of activating the second light receiving area 630 or 640 in an off state in which pixels arranged on the panel 250 of the display 160 do not display an image.

In operation 1030, the electronic device 200 may change the luminance of the display 160 based on a comparison result of the second illuminance value measured in the second light receiving area 630 or 640 and a previous second illuminance value measured in the second mode at a previous point in time according to an illuminance measurement interval. In an example, when the comparison result indicates that the second illuminance value and the previous second illuminance value are different, the electronic device 200 may change the luminance of the display 160 based on the second illuminance value. In another example, when the comparison result indicates that the second illuminance value and the previous second illuminance value are the same, the electronic device 200 may maintain the luminance of the display 160 based on the previous second illuminance value.

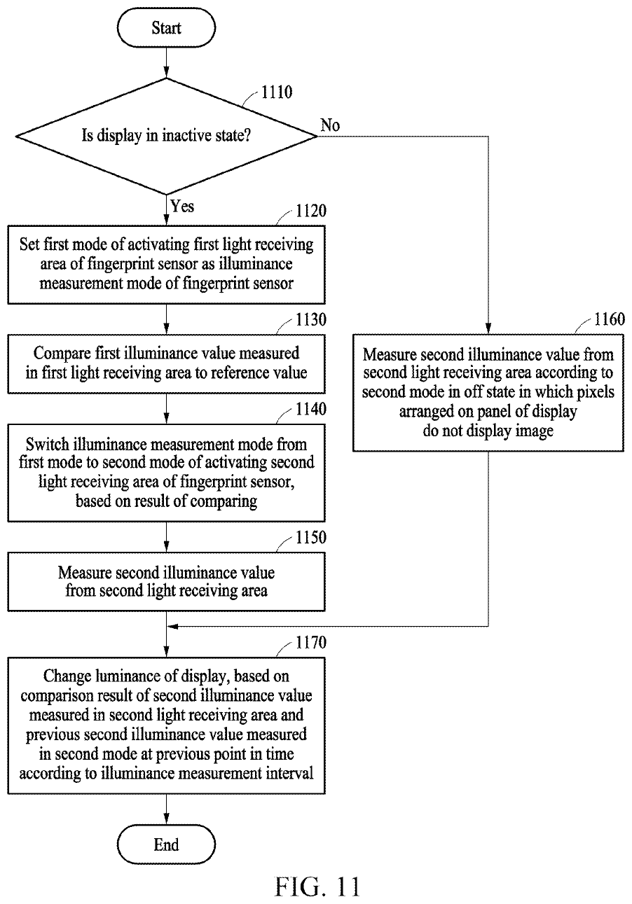

An example embodiment including an operation performed when the display 160 is determined to be in the active state will be described in greater detail below with reference to FIG. 11.

FIG. 11 is a flowchart illustrating an example method of operating the electronic device 200 to change a luminance of a display by measuring an illuminance value according to various embodiments. In the following examples, operations may be performed sequentially, but not necessarily performed sequentially. For example, the order of the operations may be changed and at least two of the operations may be performed in parallel.

The electronic device 200 (e.g., the electronic device 101 of FIG. 1) according to an example embodiment may measure an illuminance value and change the luminance of the display 160, through operations 1110 to 1170.

In operation 1110, the electronic device 200 may determine whether the display 160 is in the inactive state. In an example, it may be assumed that the display 160 is determined to be in the active state, not in the inactive state in operation 1110. In this example, in operation 1160, the electronic device 200 may measure a second illuminance value from the second light receiving area 630 or 640 of the fingerprint sensor 210 according to a second mode of activating the second light receiving area 630 or 640 in an off state in which pixels arranged on the panel 250 of the display 160 do not display an image.

In another example, when the display 160 is determined to be in the inactive state in operation 1110, the electronic device 200 may perform operations 1120 to 1150.

In operation 1120, the electronic device 200 may set a first mode of activating the first light receiving area 620 of the fingerprint sensor 210 as an illuminance measurement mode of the fingerprint sensor 210. If the first light receiving area 620 is activated according to the first mode, the electronic device 200 may measure a first illuminance value in the first light receiving area 620 according to a preset illuminance measurement interval.

In operation 1130, the electronic device 200 may compare the first illuminance value measured in the first light receiving area 620 to a reference value. In operation 1140, the electronic device 200 may switch the illuminance measurement mode from the first mode to the second mode of activating the second light receiving area 630 or 640 of the fingerprint sensor 210, based on a result of the comparing in operation 1130.

For example, the electronic device 200 may match and compare the first illuminance value and an illuminance table of the first mode. If a result of the comparing exceeds a preset variation, the electronic device 200 may switch the illuminance measurement mode from the first mode to the second mode. If the result of the comparing does not exceed the preset variation, the electronic device 200 may measure the first illuminance value in the first light receiving area 620 according to the preset illuminance measurement interval, instead of switching the illuminance measurement mode.

In operation 1150, the electronic device 200 may measure a second illuminance value from the second light receiving area 630 or 640.

In operation 1160, the electronic device 200 may change the luminance of the display 160 based on a comparison result of the second illuminance value measured in the second light receiving area 630 or 640 in operation 1150 and a previous second illuminance value measured in the second mode at a previous point in time according to the illuminance measurement interval.

FIG. 12 is a flowchart illustrating an example method of operating the electronic device 200 to perform a fingerprint detection function and an illuminance measurement function when a display is deactivated according to various embodiments. In the following examples, operations may be performed sequentially, but not necessarily performed sequentially. For example, the order of the operations may be changed and at least two of the operations may be performed in parallel.

The electronic device 200 (e.g., the electronic device 101 of FIG. 1) according to an example embodiment may perform the fingerprint detection function and the illuminance measurement function when the display 160 is deactivated, through operations 1205 to 1255. The fingerprint detection function may have a priority higher than that of the illuminance measurement function, and accordingly the electronic device 200 may preferentially process the fingerprint detection function and perform the illuminance measurement function, when the fingerprint detection function is requested.

In operation 1205, the fingerprint sensor 210 of the electronic device 200 may stand by to measure an illuminance. In operation 1210, the fingerprint sensor 210 may execute a first mode among illuminance measurement modes to measure a first illuminance value according to a preset illuminance measurement interval (e.g., 1 second).

In operation 1215, the electronic device 200 may determine whether a variation in an illuminance value (e.g., a first illuminance value) measured in a portion of light receiving areas of the fingerprint sensor 210 according to the first mode exceeds a reference value (e.g., ±5%). When it is determined that the variation in the illuminance value exceeds the reference value, the electronic device 200 may switch the first mode to the second mode in operation 1220, and accordingly the fingerprint sensor 210 may execute the second mode to measure a second illuminance value.

In operation 1225, the electronic device 200 may compare a previous illuminance value (e.g., a second illuminance value) measured in the second mode at a previous point in time to an illuminance value (e.g., a second illuminance value) measured in the second light receiving area 630 or 640 according to the second mode executed in operation 1220. If the previous illuminance value and the illuminance value are determined to be the same based on a result of the comparing in operation 1225, the electronic device 200 may return to operation 1205 to stand by to measure an illuminance.

If the previous illuminance and the illuminance value are determined to be different based on the result of the comparing in operation 1225, the electronic device 200 may change the luminance of the display 160 in operation 1230. The electronic device 200 may change the luminance of the display 160 according to the second illuminance value measured in operation 1220. Substantially, the electronic device 200 may return to operation 1205 to stand by to measure an illuminance.

The electronic device 200 according to an example embodiment may also perform the fingerprint detection function in addition to the above-described illuminance measurement function. For example, it may be assumed that during operation 1210 or 1220, an interrupt for the fingerprint sensor to perform the fingerprint detection function is generated in operation 1235. In this example, the interrupt to perform the fingerprint detection function may be generated in response to reception of a fingerprint detection request for the fingerprint sensor 210 through a touch or contact with the fingerprint sensor 210.

When the interrupt to perform the fingerprint detection function is generated, the electronic device 200 may stop an illuminance measurement of the fingerprint sensor 210. After a fingerprint recognition is performed by obtaining a fingerprint image from the fingerprint sensor 210 through operations 1240 to 1255, the electronic device 200 may activate the display 160 to be in the on state.

The electronic device 200 may stand by to detect a fingerprint by activating the fingerprint sensor 210 in operation 1240, and may determine whether fingerprint data is input within a predetermined (e.g., specified) time in operation 1245. The predetermined time may be, for example, 3 seconds or 5 seconds, but is not necessarily limited thereto.

If it is determined in operation 1245 that the fingerprint data is not input within the predetermined time, the electronic device 200 may reperform operation 1205 to stand by to measure an illuminance. If it is determined in operation 1245 that the fingerprint data is input within the predetermined time, the electronic device 200 may determine whether the input fingerprint data matches stored fingerprint data in operation 1250.

In this example, if it is determined that the input fingerprint data does not match the stored fingerprint data, the electronic device 200 may reperform operation 1245 to determine whether new fingerprint data is input within the predetermined time.

If it is determined that the input fingerprint data matches the stored fingerprint data, the electronic device 200 may perform a fingerprint recognition and activate the display 160 to be in the on state in operation 1255. An operation of the electronic device 200 performed when the display 160 is activated to be in the on state will be described in greater detail below with reference to FIG. 13.

FIG. 13 is a flowchart illustrating an example method of operating the electronic device 200 to perform a fingerprint detection function and an illuminance measurement function when a display is activated according to various embodiments. In the following examples, operations may be performed sequentially, but not necessarily performed sequentially. For example, the order of the operations may be changed and at least two of the operations may be performed in parallel.

The electronic device 200 (e.g., the electronic device 101 of FIG. 1) according to an example embodiment may perform the fingerprint detection function and the illuminance measurement function when the display 160 is activated, through operations 1305 to 1350.

Similarly to the example of FIG. 12, the fingerprint detection function may have a priority higher than that of the illuminance measurement function, and accordingly the electronic device 200 may preferentially process the fingerprint detection function and perform the illuminance measurement function, when the fingerprint detection function is requested.

In operation 1305, the fingerprint sensor 210 of the electronic device 200 may stand by to measure an illuminance In this example, the fingerprint sensor 210 may receive light using an AOR of the display 160. The “AOR” may be understood as a ratio of an off state of the panel 250 in operation 1315 to an on state of the panel 250 in operation 1310. The on state and off state of the panel 250 may be repeated.

For example, the display 160 may be assumed to include an AMOLED. In this example, the on state of the panel 250 in which pixels arranged on the panel 250 of the display 160 display an image in operation 1310, and the off state of the panel 250 in which the pixels arranged on the panel 250 of the display 160 do not display an image in operation 1315 may be repeated.

The fingerprint sensor 210 may measure an illuminance value (e.g., a second illuminance value) in the off state of the panel 250 in operation 1315 in association with the AOR of the display 160. In this example, the fingerprint sensor 210 may measure an illuminance value according to the second mode among illuminance measurement modes based on a preset illuminance measurement interval (e.g., 1 second).

For example, in a state in which the display 160 is activated, that is, in a state in which the display 160 emits light, it may be difficult to accurately measure external light due to the emitted light. In general, the display 160 in the active state may appear to eyes of a person as if the display 160 continues to be turned on, however, actually, the on state and the off state may be repeated at a high speed. However, due to such a high repetition speed, the eyes may fail to recognize the off state. In this example, a ratio between the on state and the off state may correspond to the above-described AOR. The AOR may be, for example, but not limited to, 99%: 1% or 90%: 10% or 80%: 20%.

In operation 1320, the electronic device 200 may compare a current illuminance value (e.g., a second illuminance value) measured in operation 1315 to a previous illuminance value (e.g., a previous second illuminance value) measured in the second mode at a previous point in time according to the illuminance measurement interval. When a measured illuminance changes, the electronic device 200 may apply the changed illuminance to the luminance of the display 160.

When it is determined that the current illuminance value and the previous illuminance value are the same, based on a result of the comparing in operation 1320, the electronic device 200 may stand by to measure an illuminance by the fingerprint sensor 210 in operation 1305.

When it is determined that the current illuminance value and the previous illuminance value are different, based on the result of the comparing in operation 1320, the luminance of the display 160 may be changed based on the current illuminance value measured in operation 1315.

For example, it may be assumed that an interrupt to perform the fingerprint detection function is generated during operation 1310 or 1315, as in operation 1330. In this example, the interrupt to perform the fingerprint detection function may be generated in response to reception of a fingerprint detection request for the fingerprint sensor 210 through a touch or contact with the fingerprint sensor 210.

When the interrupt to perform the fingerprint detection function is generated, the electronic device 200 may stop an illuminance measurement of the fingerprint sensor 210. The electronic device 200 may perform fingerprint authentication by obtaining a fingerprint image from the fingerprint sensor 210 through operations 1330 to 1350. Operations 1330 to 1345 of FIG. 13 are the same as or similar to operations 1235 to 1250 of FIG. 12, and accordingly further description thereof is not repeated herein.

If it is determined in operation 1345 that input fingerprint data matches stored fingerprint data, the electronic device 200 may perform the fingerprint authentication in operation 1350.

According to an example embodiment, an electronic device includes: a fingerprint sensor configured to perform at least one of a fingerprint detection function of detecting a fingerprint and an illuminance measurement function of measuring an illuminance value in a light receiving area; a display configured to display an image on a panel based on a changed luminance; and a processor configured to: activate a light receiving area of at least a portion of the fingerprint sensor based on whether the display is activated, measure an illuminance value from the light receiving area in an off state in which pixels arranged on a panel of the display do not display an image, and change a luminance of the display based on the illuminance value.

According to an example embodiment, the processor may be configured to: change the luminance of the display based on a comparison result of the illuminance value and a previous illuminance value measured at a previous point in time according to an illuminance measurement interval of the fingerprint sensor.

According to an example embodiment, the processor may be configured to: change the luminance of the display based on the illuminance value based on the comparison result indicating that the illuminance value and the previous illuminance value are different from each other, and to maintain the luminance of the display based on the previous illuminance value based on the comparison result indicating that the illuminance value and the previous illuminance value are equal to each other.

According to an example embodiment, the processor may be configured to: determine one of a first mode of activating a first light receiving area among light receiving areas and a second mode of activating a second light receiving area among the light receiving areas as an illuminance measurement mode, based on whether the display is activated, activate the first light receiving area based on the first mode being determined as the illuminance measurement mode, and activate the second light receiving area based on the second mode being determined as the illuminance measurement mode.

According to an example embodiment, the processor may be configured to: determine whether the display is activated, determine the first mode as the illuminance measurement mode based on the display being deactivated, and determine the second mode as the illuminance measurement mode based on the display being activated.

According to an example embodiment, the processor may be configured to: measure a first illuminance value in the first light receiving area activated according to the first mode, determine whether to switch the illuminance measurement mode to the second mode based on a variation in the first illuminance value, and measure a second illuminance value in the second light receiving area activated according to the second mode among the light receiving areas based on the second mode being determined as the illuminance measurement mode.

According to an example embodiment, the processor may be configured to: determine whether the variation of the first illuminance value exceeds a specified reference value, and switch the illuminance measurement mode from the first mode to the second mode based on the variation exceeding the reference value.

According to an example embodiment, the processor may be configured to: calculate the variation in the first illuminance value by matching the first illuminance value and an illuminance table of the first mode. The illuminance table of the first mode may be a table in which an illuminance value and an amount of light sensed by the fingerprint sensor in the first mode are mapped.

According to an example embodiment, the processor may be configured to: switch the illuminance measurement mode of the fingerprint sensor based on a remaining capacity of a battery of the electronic device.

According to an example embodiment, the processor may be configured to: change an illuminance measurement interval of the fingerprint sensor based on a remaining capacity of a battery of the electronic device.

According to an example embodiment, a method of operating an electronic device including a display and a fingerprint sensor may include: activating a light receiving area of at least a portion of the fingerprint sensor based on whether the display is activated; measuring an illuminance value from the light receiving area in an off state in which pixels arranged on a panel of the display do not display an image; and changing a luminance of the display based on the illuminance value.

According to an example embodiment, the changing of the luminance of the display may include: changing the luminance of the display based on a comparison result of the illuminance value and a previous illuminance value measured at a previous point in time according to an illuminance measurement interval of the fingerprint sensor.

According to an example embodiment, the changing of the luminance of the display may include: changing the luminance of the display based on the illuminance value, based on the illuminance value and the previous illuminance value being different from each other; and maintaining the luminance of the display based on the previous illuminance value, based on the illuminance value and the previous illuminance value being equal to each other.

According to an example embodiment, the activating of the light receiving area may include: determining one of a first mode of activating a first light receiving area among light receiving areas and a second mode of activating a second light receiving area among the light receiving areas as an illuminance measurement mode, based on whether the display is activated; activating the first light receiving area based on the first mode being determined as the illuminance measurement mode; and activating the second light receiving area based on the second mode being determined as the illuminance measurement mode.

According to an example embodiment, the determining of the illuminance measurement mode may include: determining whether the display is activated; determining the first mode as the illuminance measurement mode based on the display being deactivated; and determining the second mode as the illuminance measurement mode based on the display being activated.

According to an example embodiment, the measuring of the illuminance value may include: measuring a first illuminance value in the first light receiving area activated according to the first mode; determining whether to switch the illuminance measurement mode to the second mode according to a variation in the first illuminance value; and measuring a second illuminance value in a second light receiving area activated according to the second mode among the light receiving areas based on the second mode being determined as the illuminance measurement mode.

According to an example embodiment, the determining of whether to switch the illuminance measurement mode to the second mode may include: determining whether the variation in the first illuminance value exceeds a specified reference value; and switching the illuminance measurement mode from the first mode to the second mode based on the variation exceeding the reference value.

According to an example embodiment, the determining of whether the variation exceeds the reference value may include: calculating the variation in the first illuminance value by matching the first illuminance value and an illuminance table of the first mode, the illuminance table of the first mode being a table in which an illuminance value and an amount of light sensed by the fingerprint sensor in the first mode are mapped.

According to an example embodiment, the reference value may be ±5%.

According to an example embodiment, the method of operating the electronic device may further include: measuring the first illuminance value in the first light receiving area according to a specified illuminance measurement interval, instead of switching the illuminance measurement mode, based on the variation not exceeding the reference value.

According to an example embodiment, the second light receiving area may have a greater area than an area of the first light receiving area.

According to an example embodiment, the method of operating the electronic device may further include: waking up the display by applying the changed luminance in response to the display that is deactivated being activated.

According to an example embodiment, the method of operating the electronic device may further include: stopping an illuminance measurement of the fingerprint sensor and performing fingerprint recognition by obtaining a fingerprint image from the fingerprint sensor, in response to a fingerprint detection request for the fingerprint sensor being received.

According to an example embodiment, the method of operating the electronic device may further include at least one of: switching the illuminance measurement mode of the fingerprint sensor based on a remaining capacity of a battery of the electronic device; and changing an illuminance measurement interval of the fingerprint sensor based on the remaining capacity of the battery of the electronic device.

According to an example embodiment, the switching of the illuminance measurement mode of the fingerprint sensor may include at least one of: switching the illuminance measurement mode from the second mode to the first mode based on the remaining capacity of the battery of the electronic device being less than or equal to a specified reference remaining capacity; and switching the illuminance measurement mode from the first mode to the second mode based on the remaining capacity of the battery of the electronic device being greater than the reference remaining capacity.

According to an example embodiment, the changing of the illuminance measurement interval of the fingerprint sensor may include at least one of: changing the illuminance measurement interval from a first interval to a second interval longer than the first interval based on the remaining capacity of the battery of the electronic device being less than or equal to a specified reference remaining capacity; and maintaining the first interval as the illuminance measurement interval based on the remaining capacity of the battery of the electronic device being greater than the reference remaining capacity.

According to an example embodiment, the display may include an active matrix organic light emitting diode (AMOLED), and the fingerprint sensor may be configured to receive light using an AMOLED off ratio (AOR) based on the display being activated.

According to an example embodiment, a method of operating an electronic device including a display and a fingerprint sensor may include: determining whether the display is in an active state or inactive state; measuring a second illuminance value from a second light receiving area of the fingerprint sensor according to a second mode of activating the second light receiving area in an off state in which pixels arranged on a panel of the display do not display an image, based on the display being determined to be in the active state; and changing a luminance of the display based on a comparison result of the second illuminance value measured from the second light receiving area and a previous second illuminance value measured in the second mode at a previous point in time according to an illuminance measurement interval.

According to an example embodiment, the changing of the luminance of the display may include: changing the luminance of the display based on the second illuminance value, based on the comparison result indicating that the second illuminance value and the previous second illuminance value are different from each other.

According to an example embodiment, the changing of the luminance of the display may include maintaining the luminance of the display based on the previous second illuminance value, based on the comparison result indicating that the second illuminance value and the previous second illuminance value are equal to each other.

According to an example embodiment, the method of operating the electronic device may further include: setting a first mode of activating a first light receiving area of the fingerprint sensor as an illuminance measurement mode of the fingerprint sensor, based on the display being determined to be in the inactive state; comparing a first illuminance value measured in the first light receiving area to a reference value; switching the illuminance measurement mode from the first mode to the second mode of activating the second light receiving area of the fingerprint sensor based on a result of the comparing; and measuring a second illuminance value from the second light receiving area.

According to an example embodiment, the setting of the first mode may include: measuring the first illuminance value in the first light receiving area at a specified illuminance measurement interval in response to the first light receiving area being activated according to the first mode.

According to an example embodiment, the switching of the illuminance measurement mode to the second mode may include: matching and comparing the first illuminance value and an illuminance table of the first mode, the illuminance table of the first mode being a table in which an illuminance value and an amount of light sensed by the fingerprint sensor in the first mode are mapped; and switching the illuminance measurement mode from the first mode to the second mode based on a result of the comparing exceeding a specified variation.

According to an example embodiment, in the method of operating the electronic device may further include: measuring the first illuminance value in the first light receiving area according to a specified illuminance measurement interval, instead of switching the illuminance measurement mode, based on the result of the comparing not exceeding the specified variation.

According to an example embodiment, the second light receiving area may have a greater area than an area of the first light receiving area.

According to an example embodiment, the method of operating the electronic device may further include: stopping an illuminance measurement of the fingerprint sensor and performing fingerprint recognition by obtaining a fingerprint image from the fingerprint sensor, in response to a fingerprint detection request for the fingerprint sensor being received.

According to an example embodiment, the method of operating the electronic device may further include: switching the illuminance measurement mode of the fingerprint sensor based on a remaining capacity of a battery of the electronic device.

According to an example embodiment, the switching of the illuminance measurement mode of the fingerprint sensor based on the remaining capacity of the battery of the electronic device may include at least one of: switching the illuminance measurement mode from the second mode to the first mode based on the remaining capacity of the battery of the electronic device being less than or equal to a preset reference remaining capacity; and switching the illuminance measurement mode from the first mode to the second mode based on the remaining capacity of the battery of the electronic device being greater than the reference remaining capacity.

According to an example embodiment, the method of operating the electronic device may further include: changing an illuminance measurement interval of the fingerprint sensor based on the remaining capacity of the battery of the electronic device.

According to an example embodiment, the changing of the illuminance measurement interval of the fingerprint sensor may include at least one of: changing the illuminance measurement interval from a first interval to a second interval longer than the first interval based on the remaining capacity of the battery of the electronic device being less than or equal to a specified reference remaining capacity; and maintaining the first interval as the illuminance measurement interval based on the remaining capacity of the battery of the electronic device being greater than the specified reference remaining capacity.

According to an example embodiment, the display may include an AMOLED, and the fingerprint sensor may be configured to receive light using an AOR based on the display being activated.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a fingerprint sensor configured to perform at least one of a fingerprint detection function of detecting a fingerprint and an illuminance measurement function of measuring an illuminance value in a light receiving area;
a display configured to display an image on a panel based on a changed luminance; and
a processor configured to: activate a light receiving area of at least a portion of the fingerprint sensor based on whether the display is activated, measure an illuminance value from the light receiving area in an off state in which pixels arranged on the panel of the display do not display an image, and change a luminance of the display based on the illuminance value.

2. The electronic device of claim 1, wherein the processor is configured to:
change the luminance of the display based on a comparison result of the illuminance value and a previous illuminance value measured at a previous point in time according to an illuminance measurement interval of the fingerprint sensor.

3. The electronic device of claim 1, wherein the processor is configured to:
change the luminance of the display based on the illuminance value, based on the comparison result indicating that the illuminance value and the previous illuminance value are different from each other; and
maintain the luminance of the display based on the previous illuminance value, based on the comparison result indicating that the illuminance value and the previous illuminance value are equal to each other.

4. The electronic device of claim 1, wherein the processor is configured to:
determine one of a first mode of activating a first light receiving area among light receiving areas and a second mode of activating a second light receiving area among the light receiving areas as an illuminance measurement mode of the fingerprint sensor, based on whether the display is activated;
activate the first light receiving area based on the first mode being determined as the illuminance measurement mode; and
activate the second light receiving area based on the second mode being determined as the illuminance measurement mode.

5. The electronic device of claim 4, wherein the processor is configured to:
determine whether the display is activated;
determine the first mode as the illuminance measurement mode based on the display being deactivated; and
determine the second mode as the illuminance measurement mode based on the display being activated.

6. The electronic device of claim 5, wherein the processor is configured to:
measure a first illuminance value in the first light receiving area activated according to the first mode;
determine whether to switch the illuminance measurement mode to the second mode based on a variation in the first illuminance value; and
measure a second illuminance value in the second light receiving area activated according to the second mode among the light receiving areas based on the second mode being determined as the illuminance measurement mode.

7. The electronic device of claim 6, wherein the processor is configured to:
determine whether the variation in the first illuminance value exceeds a specified reference value; and
switch the illuminance measurement mode from the first mode to the second mode based on the variation exceeding the specified reference value.

8. The electronic device of claim 7, wherein the processor is configured to: calculate the variation in the first illuminance value by matching the first illuminance value and an illuminance table of the first mode, the illuminance table of the first mode being a table in which an illuminance value and an amount of light sensed by the fingerprint sensor in the first mode are mapped.

9. The electronic device of claim 4, wherein the processor is configured to: switch the illuminance measurement mode based on a remaining capacity of a battery of the electronic device.

10. The electronic device of claim 1, wherein the processor is configured to: change an illuminance measurement interval of the fingerprint sensor based on a remaining capacity of a battery of the electronic device.

11. A method of operating an electronic device comprising a display and a fingerprint sensor, the method comprising:
activating a light receiving area of at least a portion of the fingerprint sensor based on whether the display is activated;
measuring an illuminance value from the light receiving area in an off state in which pixels arranged on a panel of the display do not display an image; and
changing a luminance of the display based on the illuminance value.

12. The method of claim 11, wherein the changing of the luminance of the display comprises changing the luminance of the display based on a comparison result of the illuminance value and a previous illuminance value measured at a previous point in time according to an illuminance measurement interval of the fingerprint sensor.

13. The method of claim 11, wherein the changing of the luminance of the display comprises:
changing the luminance of the display based on the illuminance value, based on the comparison result indicating that the illuminance value and the previous illuminance value are different from each other; and
maintaining the luminance of the display based on the previous illuminance value, based on the comparison result indicating that the illuminance value and the previous illuminance value are equal to each other.

14. The method of claim 11, wherein the activating of the light receiving area comprises:
determining one of a first mode of activating a first light receiving area among light receiving areas and a second mode of activating a second light receiving area among the light receiving areas as an illuminance measurement mode of the fingerprint sensor, based on whether the display is activated;
activating the first light receiving area based on the first mode being determined as the illuminance measurement mode; and
activating the second light receiving area based on the second mode being determined as the illuminance measurement mode.

15. The method of claim 14, wherein the determining of the illuminance measurement mode comprises:
determining whether the display is activated;
determining the first mode as the illuminance measurement mode based on the display being deactivated; and
determining the second mode as the illuminance measurement mode based on the display being activated.

16. The method of claim 15, wherein the measuring of the illuminance value comprises:
measuring a first illuminance value in the first light receiving area activated according to the first mode;
determining whether to switch the illuminance measurement mode to the second mode according to a variation in the first illuminance value; and
measuring a second illuminance value in the second light receiving area activated according to the second mode among the light receiving areas based on the second mode being determined as the illuminance measurement mode.

17. The method of claim 16, wherein the determining of whether to switch the illuminance measurement mode to the second mode comprises:
determining whether the variation in the first illuminance value exceeds a specified reference value; and
switching the illuminance measurement mode from the first mode to the second mode based on the variation exceeding the specified reference value.

18. The method of claim 17, wherein the determining of whether the variation exceeds the specified reference value comprises: calculating the variation in the first illuminance value by matching the first illuminance value and an illuminance table of the first mode, the illuminance table of the first mode being a table in which an illuminance value and an amount of light sensed by the fingerprint sensor in the first mode are mapped.

19. The method of claim 13, further comprising at least one of:
switching the illuminance measurement mode based on a remaining capacity of a battery of the electronic device; and
changing an illuminance measurement interval of the fingerprint sensor based on the remaining capacity of the battery of the electronic device.

20. A non-transitory computer-readable storage medium storing instructions that, when executed by a processor, cause the processor to perform the operations of claim 11.
